(19) United States
(12) Patent Application Publication
(10) Pub. No.: US 2016/0254074 A1
(43) Pub. Date: Sep. 1, 2016

(54) COPPER ALLOY WIRE, COPPER ALLOY STRANDED WIRE, COATED ELECTRIC WIRE, WIRE HARNESS, AND METHOD FOR PRODUCING COPPER ALLOY WIRE

(71) Applicants: AUTONETWORKS TECHNOLOGIES, LTD., Yokkaichi-shi, Mie (JP); SUMITOMO WIRING SYSTEMS, LTD., Yokkaichi-shi, Mie (JP); SUMITOMO ELECTRIC INDUSTRIES, LTD., Osaka-shi, Osaka (JP)

(72) Inventors: Hiroyuki KOBAYASHI, Yokkaichi, Mie (JP); Masahiro NAKAMURA, Yokkaichi, Mie (JP); Akiko INOUE, Yokkaichi, Mie (JP); Yasuyuki OOTSUKA, Yokkaichi, Mie (JP)

(21) Appl. No.: 15/033,472

(22) PCT Filed: Oct. 15, 2014
(86) PCT No.: PCT/JP2014/077380

§ 371 Date: Apr. 29, 2016

(30) Foreign Application Priority Data
Nov. 1, 2013 (JP) 2013-227803

(51) Int. Cl. H01B 7/00; C22C 9/00; H01B 13/00; B21C 1/02; H01B 1/02; C22F 1/08; B22D 21/00

(52) U.S. Cl. CPC H01B 7/0009; C22F 1/08; C22C 9/00; B22D 21/005; B21C 1/02; H01B 1/026; H01B 7/0045; H01B 13/0016; H01B 13/0006

(57) ABSTRACT

A copper alloy wire for use as a conductor of an automotive electric wire includes in mass percent, Fe: 0.4% or more and 2.5% or less, Ti: 0.01% or more and 1.0% or less, one or more selected from the group consisting of Mg, Sn, Ag, Ni, In, Zn, Cr, Al and P: 0.01% or more and 2.0% or less in total, and the balance being Cu and unavoidable impurities. An O content in the copper alloy wire is preferably 20 ppm or less. A tensile strength of the copper alloy wire is preferably 450 MPa or more. An element wire elongation of the copper alloy wire is preferably 5% or more. An electrical conductivity of the copper alloy wire is preferably 62% IACS or more.

### TECHNICAL FIELD

The present invention relates to a copper alloy wire, a copper alloy stranded wire, a coated electric wire and a method for producing the copper alloy wire, particularly suitable for application to automotive electric wires.

### BACKGROUND ART

As part of the demand for weight reduction of automobiles, weight reduction of automotive electric wires is desired. Weight reduction of an automotive electric wire can be accomplished by reducing the diameter of a conductor. However, merely reducing the diameter of the conductor can result in a case where requirements such as strength properties cannot be met.

For example, for wire branching, a plurality of wire conductors are sometimes joined together by ultrasonic welding, in which case a ultrasonic welded portion must have high strength so as not to be peeled during use. One way to evaluate a strength of the ultrasonic welded portion is measurement of the peel strength as described later. It is necessary to prevent a decrease in the peel strength.

Patent Document 1 proposes techniques to increase the peel strength of a conductor formed of a plurality of metal element wires twisted together. Specifically, the proposals include reducing the number of strands to be twisted together to three so that each of the metal element wires has a larger diameter than in cases where a greater number of metal element wires are used to thereby increase the strength per element wire and limiting the thickness of a surface oxide film of each metal element wire to thereby improve the ultrasonic weldability.

### PRIOR ART DOCUMENT

### Patent Document

Patent Document 1: JP-A-2012-146431

### SUMMARY OF THE INVENTION

### Problem to be Solved by the Invention

Although Patent Document 1 is considered to be effective in increasing the peel strength to some extent, it does not disclose any approach to impact resistance, which is a requirement for automotive electric wires. Moreover, Patent Document 1 limits the number of metal element wires to be twisted together to three and therefore still poses a problem in that the technique cannot be employed for typical seven-strand wire applications.

Wires employing a metal element wire made of a copper alloy for increased strength have a lower impact resistance energy because of lower elongation of the element wire itself than in cases where a soft material such as tough pitch copper is employed as an element wire, and therefore they can break when, for example, a load is abruptly applied thereto in a short period of time. Thus, when a copper alloy is employed for the metal element wire, improvement of impact resistance is also required.

The present invention is designed to provide a copper alloy stranded wire, a coated electric wire, and a wire harness which have high strength, high elongation, and high peel strength as well as excellent impact resistance even when they are of the type having a relatively small conductor cross-sectional area, and the present invention is also designed to provide a copper alloy wire for use in these products as well as a method for producing the copper alloy wire.

### Means for Solving the Problem

According to a first aspect, there is provided a copper alloy wire for use as a conductor of an automotive electric wire, the copper alloy wire including in mass percent:

Fe: 0.4% or more and 2.5% or less,

Ti: 0.01% or more and 1.0% or less,

one or more selected from the group consisting of Mg, Sn, Ag, Ni, In, Zn, Cr, Al and P: 0.01% or more and 2.0% or less in total, and

the balance being Cu and unavoidable impurities.

According to another aspect, there is provided a copper alloy stranded wire including seven copper alloy wires that are twisted together.

According to still another aspect, there is provided a coated electric wire including: a conductor wire formed of a copper alloy stranded wire including a plurality of the copper alloy wires twisted together or a compressed wire obtained by subjecting the copper alloy stranded wire to compression forming; and an insulation coating layer covering an outer periphery of the conductor wire.

According to still another aspect, there is provided a wire harness including the coated electric wire and a terminal attached to an end of the coated electric wire.

According to still another aspect, there is provided a method for producing a copper alloy wire for use as a conductor of an automotive electric wire, the method including the steps of:

forming a cast material including in mass percent Fe: 0.4% or more and 2.5% or less, Ti: 0.01% or more and 1.0% or less, one or more selected from the group consisting of Mg, Sn, Ag, Ni, In, Zn, Cr, Al and P: 0.01% or more and 2.0% or less in total, and the balance being Cu and unavoidable impurities;

forming a wrought product by subjecting the cast material to plastic working;

forming a drawn wire by subjecting the wrought product to wire drawing; and

subjecting the drawn wire to heat treatment so that the drawn wire has a tensile strength of 450 MPa or more and an elongation of 5% or more.

### Effects of the Invention

The copper alloy wire includes chemical components that are intentionally limited to the specified ranges. With the limitation, it is possible to achieve improvement in strength, toughness, and impact resistance while inhibiting deterioration of wire drawability and electrical conductivity.

Typically, conventional copper alloys designed to have increased strength exhibit increased strength but are greatly reduced in wire drawability, electrical conductivity, toughness, or impact resistance, and no copper alloys that satisfy all of these properties have been developed. In contrast, the copper alloy wire successfully satisfies all of the aforementioned properties, which has been achieved by addition of suitable amounts of Fe and Ti and addition of suitable amounts of one or more elements selected from the group consisting of Mg, Sn, Ag, Ni, In, Zn, Cr, Al and P so that influence of degradation of properties that may be caused by excessive addition of the additive elements can be reduced.

Furthermore, with the production method, it is possible to readily produce such excellent copper alloy wires.

Furthermore, by using the excellent copper alloy wire as an element wire, it is possible to obtain a copper alloy stranded wire, a coated electric wire, and a wire harness that can be effectively utilized in automotive applications while achieving weight reduction.

### BRIEF DESCRIPTION OF THE DRAWINGS

FIG. 1 is an illustration of a configuration of a coated electric wire in Example 2.

FIG. 2 is an illustration of another configuration of the coated electric wire in Example 2.

FIG. 3 is an illustration of the coated electric wire with a terminal joined to an end of the coated electric wire in Example 2.

FIG. 4 is an illustration of the crimp height (C/H) of a crimped portion in Example 2.

FIG. 5 is an illustration of a method by which the peel strength is measured in Example 2.

FIG. 6 is an illustration of a method by which the impact resistance is measured in Example 2.

### MODE FOR CARRYING OUT THE INVENTION

The reasons for the limitations to the chemical components of the copper alloy wire are described.

Fe: 0.4% or More and 2.5% or Less in Mass Percent:

Fe (iron) is an element effective in increasing the strength of a copper material and needs to be added in an amount of 0.4% or more to produce the advantageous effect, with a preferred amount being 0.5% or more. On the other hand, excessive addition of Fe can result in deterioration of wire drawability and electrical conductivity, and therefore it is necessary to limit the Fe content to not more than 2.5% in mass percent, with a preferred content being not more than 1.5% in mass percent.

Ti: 0.01% or More and 1.0% or Less in Mass Percent:

Similarly to Fe, Ti (titanium) is an element effective in increasing the strength of a copper material and needs to be added in an amount of 0.01% or more to produce the advantageous effect, with a preferred amount being 0.1% or more. On the other hand, excessive addition of Ti can result in deterioration of wire drawability and electrical conductivity, and therefore it is necessary to limit the Ti content to not more than 1.0% in mass percent, with a preferred content being not more than 0.5% in mass percent.

One or More Selected from the Group Consisting of Mg, Sn, Ag, Ni, in, Zn, Cr, Al and P: 0.01% or More and 2.0% or Less in Mass Percent in Total:

Mg (magnesium), Sn (tin), Ag (silver), Ni (nickel), In (indium), Zn (zinc), Cr (chromium), Al (aluminum) and P (phosphorus) are all effective in increasing the strength, toughness and impact resistance of a copper material, and one or more of the elements are to be added in an amount of 0.01% or more in total. On the other hand, excessive addition of these elements can result in deterioration of the other properties, and therefore the total content is limited to not more than 2.0% in mass percent. While Mg, Sn, Ni, In, Cr, Al and P have a great advantage in increasing strength, their excessive addition can result in deterioration of electrical conductivity. Ag and Zn are expected to produce the advantageous effect of increasing strength without causing much deterioration of electrical conductivity, but their excessive addition may cause defects such as flaws during casting.

More specifically, when Mg is added, the amount of Mg alone to be added preferably ranges from 0.01% to 0.5% in mass percent, inclusive, and more preferably from 0.01% to 0.2% in mass percent, inclusive. This makes it possible to produce the advantageous effect of increasing strength by virtue of addition of Mg and also to prevent deterioration of electrical conductivity and toughness as well as deterioration of wire drawability due to excessive addition of Mg.

When Sn is added, the amount of Sn alone to be added preferably ranges from 0.01% to 0.7% in mass percent, inclusive, and more preferably from 0.01% to 0.3% in mass percent, inclusive. This makes it possible to produce the advantageous effect of increasing strength by virtue of addition of Sn and also to prevent deterioration of electrical conductivity due to excessive addition of Sn.

When Ag is added, the amount of Ag alone to be added preferably ranges from 0.01% to 1% in mass percent, inclusive, and more preferably from 0.01% to 0.2% in mass percent, inclusive. This makes it possible to produce the advantageous effect of increasing strength by virtue of addition of Ag and also to prevent defects such as flaws during casting due to excessive addition of Ag.

When Ni, In, Zn, Cr, Al or P is added, the total content preferably ranges from 0.01% to 0.3% in mass percent, inclusive, and more preferably the total content ranges from 0.01% to 0.2% in mass percent, inclusive. This makes it possible to produce the advantageous effect of increasing strength by virtue of addition of these elements and also to prevent deterioration of electrical conductivity and toughness as well as deterioration of wire drawability due to excessive addition of these elements.

In addition, in the chemical composition of the copper alloy wire, an O (oxygen) content is preferably 20 ppm or less. By limiting the O content to be within this range, it is possible to inhibit production of oxides with the additive elements, such as titanium oxide (TiO₂), and thereby to effectively produce the advantageous effects by virtue of the additive elements. The O content is preferably not more than 10 ppm.

Furthermore, by virtue of the employed chemical composition and the production method described blow, the copper alloy wire is readily provided with the following properties. Specifically, the copper alloy has a tensile strength of 450 MPa or more. As a result, even in cases where an electrical wire formed of the copper alloy wire has a reduced conductor cross-sectional area for weight reduction, the overall strength of the electrical wire is still maintained to be within a range sufficient for automotive applications.

Furthermore, the copper alloy wire has an element wire elongation of 5% or more. As a result, even in cases where an electrical wire formed of the copper alloy wire has a reduced conductor cross-sectional area for weight reduction, the overall impact resistance energy of the electrical wire is still maintained to be within a range sufficient for automotive applications.

Furthermore, the copper alloy wire has an electrical conductivity of 62% IACS or more. As a result, even in cases where an electrical wire formed of the copper alloy wire has a reduced conductor cross-sectional area for weight reduction, the overall electrical conductivity of the electrical wire are still maintained to be within a range sufficient for automotive applications.

Furthermore, the copper alloy wire has a wire diameter of 0.3 mm or less, or may have a wire diameter of not more than 0.25 mm or not more than 0.20 mm. This makes it possible to readily reduce the conductor cross-sectional area of an electrical wire formed of a stranded wire including a plurality of the copper alloy wires.

Next, a copper alloy stranded wire formed of seven copper alloy wires twisted together has a conductor cross-sectional area of 0.22 mm² or less. This can be achieved when the wire diameter of the copper alloy wire is not more than 0.3 mm.

Furthermore, by using the copper alloy wire as an element wire, the copper alloy stranded wire has a total elongation of 10% or more and a peel strength of 13 N or more, and further has an impact resistance energy of 5 J/m or more.

Furthermore, the copper alloy wire may be used in the form of a coated electric wire including: a conductor wire formed of a copper alloy stranded wire including a plurality of the copper alloy wires twisted together or a compressed wire obtained by subjecting the copper alloy stranded wire to compression forming; and an insulation coating layer covering the outer periphery of the conductor wire. In this case, the material of the insulation coating layer may be selected from a variety of known resin materials. Examples of such materials include PVC (polyvinyl chloride), a variety of engineering plastics, and a variety of halogen-free materials. The insulation coating layer may have a thickness ranging from 0.1 mm to 0.4 mm, inclusive.

The coated electric wire can form a wire harness by having a terminal crimped and secured onto its end. The terminal may be formed of a fitting that may be of a variety of types.

In the wire harness, by virtue of including the high strength conductor formed of the copper alloy wire, a terminal crimp strength of the terminal to the coated electric wire can be 50 N or more.

Next, in the method for producing the copper alloy wire, a step of forming a cast material having the aforementioned chemical composition is performed firstly as described above. In this step, for example, electrolytic copper, a base alloy including copper and additive elements, and the like are melted, and a reducing gas or a reducing agent such as wood is added thereto to produce an oxygen-free molten copper aimed at the chemical composition, and subsequently the molten copper is cast.

For the casting, any casting technique may be employed, examples of which include continuous casting using a movable mold or a frame-shaped stationary mold and mold casting using a box-shaped stationary mold. With continuous casting particularly, the molten alloy can be rapidly solidified so that the additive elements can be held in solid solution, and therefore a subsequent solution treatment need not be performed.

The resultant cast material is subjected to plastic working to form a wrought product. An example of the plastic working that may be employed is rolling or extruding by hot working or cold working. In the case where the cast material is produced using a method other than continuous casting, it is preferred that a solution treatment be performed before or after, or before and after, the plastic working.

The resultant wrought product is subjected to wire drawing to form a drawn wire. The drawing reduction rate may be appropriately selected depending on a desired wire diameter. The resultant drawn wires may be twisted together in a desired number to form a stranded wire. Further, the stranded wire may be subjected to compression forming to form a compressed wire.

The subsequent heat treatment is performed so that the drawn wire (element wire) has a tensile strength of 450 MPa or more and an elongation of 5% or more. The heat treatment may be performed on the drawn wire, stranded wire, or compressed wire. The heat treatment may be performed both after wire drawing and after twisting. This heat treatment is a process for softening the wire to an extent such that the strength of the wire, which has been increased by refining of the crystal structure and work hardening, would not extremely decrease, and also, for increasing the toughness. Preferably, this heat treatment is performed so that the total elongation in the form of a stranded wire or a compressed wire is made not less than 10%.

As for specific conditions for the heat treatment, strictly speaking, optimal ranges depend on the chemical components. For example, the conditions include a holding time ranging from 4 hours to 16 hours and a treatment temperature ranging from 400° C. to 500° C. If the treatment temperature is less than 400° C. or the treatment time is less than 4 hours, the above-described advantageous effects cannot be produced sufficiently and therefore it becomes difficult to achieve the desired elongation. If the treatment temperature is more than 500° C., coarsening of precipitates may occur, which can result in insufficient strength. If the treatment time is more than 16 hours, the prolonged treatment time can result in higher costs.

### EXAMPLE

### Example 1

Examples of the copper alloy wire and its production method will be described together with comparative examples. In this example, copper alloy wires having the chemical compositions shown in Table 1 were produced and evaluated. Samples 1-1 to 1-17 each have a chemical composition including in mass percent, Fe: 0.4% or more and 2.5% or less, Ti: 0.01% or more and 1.0% or less, one or more selected from the group consisting of Mg, Sn, Ag, Ni, In, Zn, Cr, Al and P: 0.01% or more and 2.0% or less in total, and the balance being Cu and unavoidable impurities. On the other hand, Sample C101, a comparative example, is a copper alloy with only Fe and a trace amount of Ti being added as alloying elements, and Sample C102, a comparative example, is a copper alloy with only Mg being added as an alloying element.

For production of the copper alloy wires, firstly, electrolytic copper of 99.99% or more purity and a parent alloy including additive elements were loaded into a high-purity carbon crucible and subjected to vacuum melting in a continuous casting machine, to produce molten mixed metals having the compositions shown in Table 1.

The resultant molten mixed metals were continuously cast using a high-purity carbon mold to produce cast materials having a circular cross sectional shape with a wire diameter of 16 mm. The resultant cast materials were swaged to a diameter of 12 mm, and then subjected to a solution treatment at a temperature of 950° C. for a holding time of 1 hour. Thereafter, wire drawing was performed to a diameter of 0.215 mm or a diameter of 0.16 mm, and then heat treatments under the conditions shown in Table 1 were performed to thereby produce the copper alloy wires.

Evaluations of the properties of the resultant copper alloy wires were made as follows. Firstly, a tensile test was conducted with a gauge length GL of 250 mm and a pulling rate of 50 mm/min to measure the tensile strength (MPa) and elongation (element wire elongation) (%). Also, the electrical resistance over a gauge length GL of 1000 mm was measured to calculate the electrical conductivity. The obtained results are shown in Table 1 together.

TABLE 1

| | Chemical composition | | | | | | | | | | | | |
|---|---|---|---|---|---|---|---|---|---|---|---|---|---|
| Sample | mass % | | | | | | | | | | | | ppm |
| No. | Cu | Fe | Ti | Mg | Sn | Ag | Ni | In | Cr | Zn | Al | P | O |
| 1-1 | Bal. | 0.70 | 0.28 | 0.06 | — | — | — | — | — | — | — | — | 5 |
| 1-2 | Bal. | 0.91 | 0.33 | 0.01 | — | — | — | — | — | — | — | — | 10 |
| 1-3 | Bal. | 0.71 | 0.26 | 0.02 | — | — | — | — | — | — | — | — | 10 |
| 1-4 | Bal. | 0.71 | 0.14 | 0.13 | — | — | — | — | — | — | — | — | 10 |
| 1-5 | Bal. | 0.51 | 0.11 | 0.13 | — | — | — | — | — | — | — | — | 20 |
| 1-6 | Bal. | 1.00 | 0.38 | 0.04 | — | — | — | — | — | — | — | — | 10 |
| 1-7 | Bal. | 1.00 | 0.20 | 0.13 | — | — | — | — | — | — | — | — | 10 |
| 1-8 | Bal. | 0.50 | 0.44 | 0.14 | — | — | — | — | — | — | — | — | 5 |
| 1-9 | Bal. | 0.51 | 0.44 | 0.05 | — | — | — | — | — | — | — | — | 5 |
| 1-10 | Bal. | 0.71 | 0.14 | — | 0.05 | — | — | — | — | — | — | — | 5 |
| 1-11 | Bal. | 0.71 | 0.14 | — | 0.10 | — | — | — | — | — | — | — | 5 |
| 1-12 | Bal. | 0.71 | 0.14 | — | 0.15 | — | — | — | — | — | — | — | 5 |
| 1-13 | Bal. | 0.71 | 0.14 | — | 0.20 | — | — | — | — | — | — | — | 5 |
| 1-14 | Bal. | 0.71 | 0.30 | — | — | 0.02 | 0.01 | — | — | — | — | — | 5 |
| 1-15 | Bal. | 0.71 | 0.30 | — | — | — | — | 0.02 | 0.01 | 0.01 | 0.01 | 0.01 | 10 |
| 1-16 | Bal. | 2.10 | 0.01 | — | — | — | — | — | — | 0.07 | — | 0.04 | 10 |
| 1-17 | Bal. | 0.75 | 0.70 | 0.02 | — | — | — | — | — | — | — | — | 5 |
| C101 | Bal. | 0.30 | 0.005 | — | — | — | — | — | — | — | — | — | 30 |
| C102 | Bal. | — | — | 0.26 | — | — | — | — | — | — | — | — | 5 |

| | Copper | | | | | |
|---|---|---|---|---|---|---|
| | alloy wire | | | Properties | | |
| | Wire | Heat treatment | | Tensile | | Electrical |
| Sample | diameter | Temperature | Time | strength | Elongation | conductivity |
| No. | (mm) | (° C.) | (h) | (MPa) | (%) | (% IACS) |
| 1-1 | 0.215 | 450 | 4 | 550 | 7 | 72 |
| 1-2 | 0.16 | 400 | 16 | 524 | 7 | 72 |
| 1-3 | 0.16 | 400 | 16 | 563 | 7 | 69 |
| 1-4 | 0.16 | 450 | 8 | 556 | 8 | 65 |
| 1-5 | 0.16 | 500 | 4 | 527 | 9 | 66 |
| 1-6 | 0.16 | 450 | 4 | 581 | 9 | 73 |
| 1-7 | 0.16 | 450 | 8 | 546 | 9 | 65 |
| 1-8 | 0.16 | 500 | 4 | 617 | 7 | 65 |
| 1-9 | 0.16 | 500 | 4 | 579 | 7 | 73 |
| 1-10 | 0.16 | 450 | 8 | 496 | 9 | 66 |
| 1-11 | 0.16 | 450 | 8 | 510 | 10 | 64 |
| 1-12 | 0.16 | 450 | 8 | 524 | 10 | 62 |
| 1-13 | 0.16 | 500 | 4 | 458 | 12 | 62 |
| 1-14 | 0.16 | 450 | 8 | 505 | 10 | 65 |
| 1-15 | 0.16 | 450 | 8 | 510 | 10 | 62 |
| 1-16 | 0.215 | 450 | 8 | 456 | 7 | 63 |
| 1-17 | 0.16 | 500 | 8 | 610 | 6 | 62 |
| C101 | 0.16 | 450 | 8 | 380 | 10 | 80 |
| C102 | 0.16 | — | — | 802 | 2 | 78 |

As can be seen from Table 1, Samples 1-1 to 1-17 each exhibited excellent properties with both the tensile strength and elongation being excellent and also the electrical conductivity being sufficiently high. On the other hand, Sample C101 exhibited a low tensile strength although the elongation was very high and thus it is seen that Sample C101 is not suitable as a material for an electrical wire aimed at achieving weight reduction by virtue of increased strength. Sample C102 exhibited a low elongation although the tensile strength was very high, and thus there is a concern about deterioration of impact resistance or other properties.

### Example 2

In this example, copper alloy wires having the chemical compositions shown in Table 2 were produced and then seven copper alloy wires were twisted together to form stranded wires for evaluation. Samples 2-1 to 2-15 each have a chemical composition including in mass percent, Fe: 0.4% or more and 2.5% or less, Ti: 0.01% or more and 1.0% or less, one or more selected from the group consisting of Mg, Sn, Ag, Ni, In, Zn, Cr, Al and P: 0.01% or more and 2.0% or less in total, and the balance being Cu and unavoidable impurities. On the other hand, Sample C201, a comparative example, is a copper alloy with only Fe and a trace amount of Ti being added as alloying elements, and Sample C202, a comparative example, is a copper alloy with only Mg being added as an alloying element.

For production of the copper alloy wires, firstly, electrolytic copper of 99.99% or more purity and a parent alloy including additive elements were loaded into a high-purity carbon crucible and subjected to vacuum melting in a continuous casting machine, to produce molten mixed metals having the compositions shown in Table 2.

The resultant molten mixed metals were continuously cast using a high-purity carbon mold to produce cast materials having a circular cross sectional shape with a wire diameter of 12.5 mm. The resultant cast material was subjected to extruding (or rolling is also employable) to have a diameter of 8 mm. Thereafter, wire drawing was performed to a diameter of 0.16 mm or a diameter of 0.215 mm to produce the copper alloy wires. Seven copper alloy wires were twisted together at a twist pitch of 16 mm to form stranded wires, which were then subjected to compression forming, and thereafter, heat treatments under the conditions shown in Table 2 were performed to produce copper alloy stranded wires.

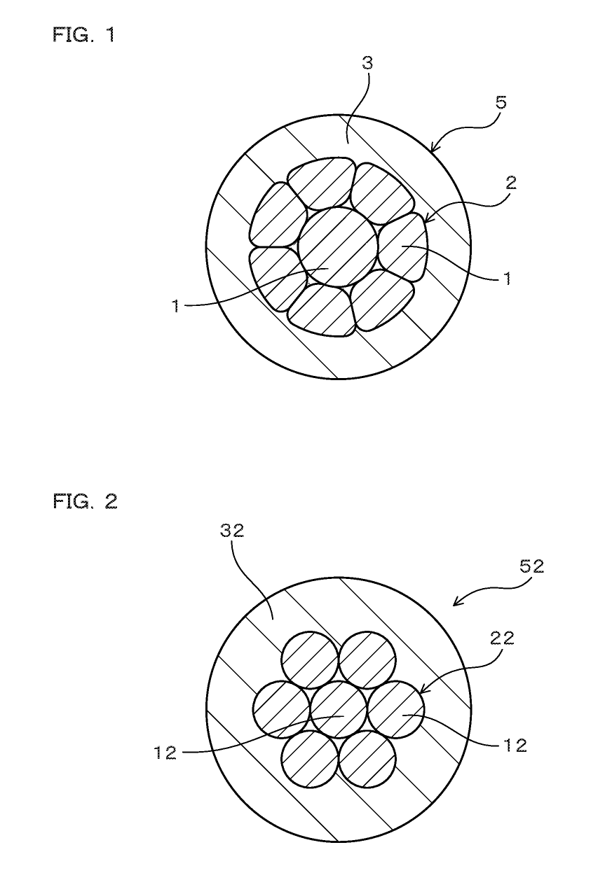

Next, extrusion was performed to produce coated electric wires each including a conductor wire made of the resultant copper alloy stranded wire with the outer periphery of the conductor wire coated with an insulation coating layer of 0.2 mm thickness as shown in Table 3. As shown in FIG. 1, a resultant coated electric wire 5 has a cross-sectional shape such that the periphery of a copper alloy stranded wire 2 is coated with an insulation coating layer 3, the copper alloy stranded wire 2 being formed by twisting seven copper alloy wires 1 together and then performing circular compression. Alternatively, as shown in FIG. 2, there may be provided a coated electric wire 52 having a cross-sectional shape such that the periphery of a copper alloy stranded wire 22 is coated with an insulation coating layer 32, the copper alloy stranded wire 22 being formed by twisting seven copper alloy wires 12 together, omitting a process of compression forming.

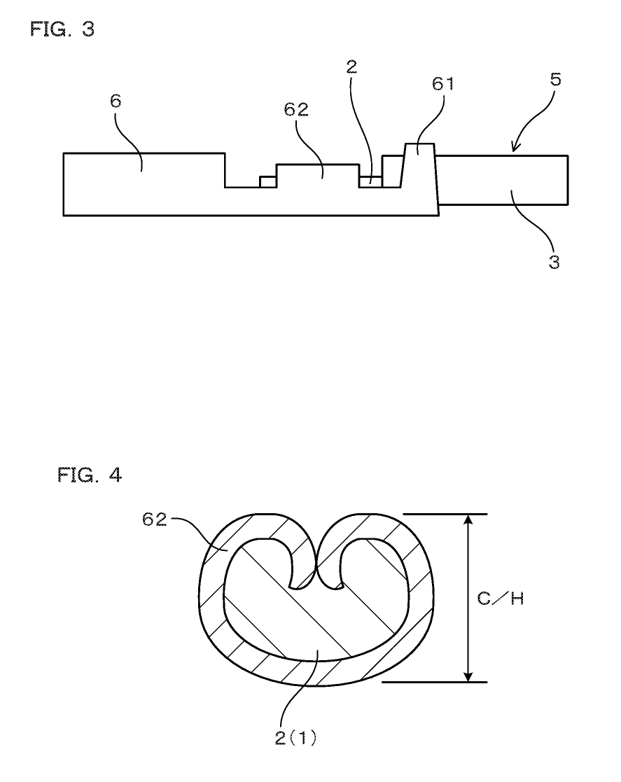

Next, as shown in FIG. 3, a terminal 6 was connected to an end of the coated electric wire 5 to produce a wire harness. The terminal 6 includes an insulation barrel 61 for securing the insulation coating layer 3 of the coated electric wire 5 and a wire barrel 62 for securing a conductor wire (copper alloy stranded wire 2) that has been exposed by stripping the insulation coating layer 3. Crimping of the coated electric wire 5 by means of the barrels 61, 62 is carried out by plastically deforming the barrels 61, 62 using a die (not shown) of a predetermined shape. In this example, as shown in FIG. 4, a wire harness 7 was produced by crimping the terminal 6 onto the coated electric wire 5 at a crimp height (C/H) set to be 0.76 in each case.

In this example, evaluations of the properties of the resultant copper alloy stranded wires were made as follows. Firstly, a tensile test was conducted with a gauge length GL of 250 mm and a pulling rate of 50 mm/min to measure the tensile strength (MPa) and elongation (total elongation) (%). Also, the electrical resistance over a gauge length GL of 1000 mm was measured to calculate the electrical conductivity. The obtained results are shown in Table 2.

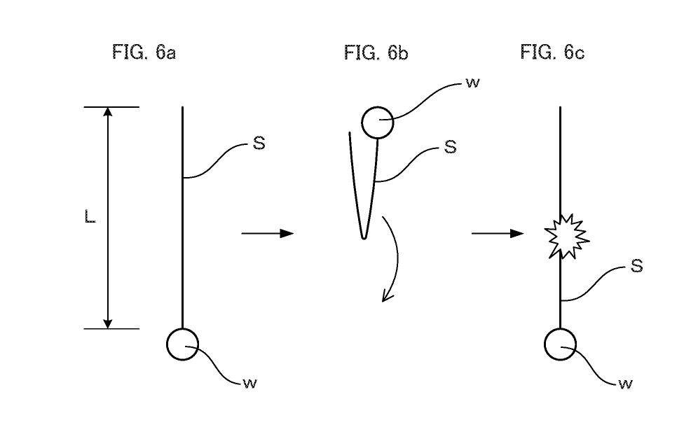

Impact resistance was measured using a test method as shown in FIG. 6. A weight w was attached to an end of a sample S (sample length L: 1 m) (FIG. 6(a)) and the weight w was lifted up to 1 m (FIG. 6(b)), and thereafter the weight w was allowed to free-fall (FIG. 6(c)). Then, the maximum weight (kg) of the weight w up to which the sample S did not break was measured, and the product of the measured weight multiplied by the acceleration of gravity (9.8 m/s²) and a fall distance 1 m was divided by the fall distance, and the result was designated as the impact resistance (J/m or (N·m)/m) for evaluation. In this manner, the impact resistance energy was measured for evaluation. The obtained results are shown in Table 2.

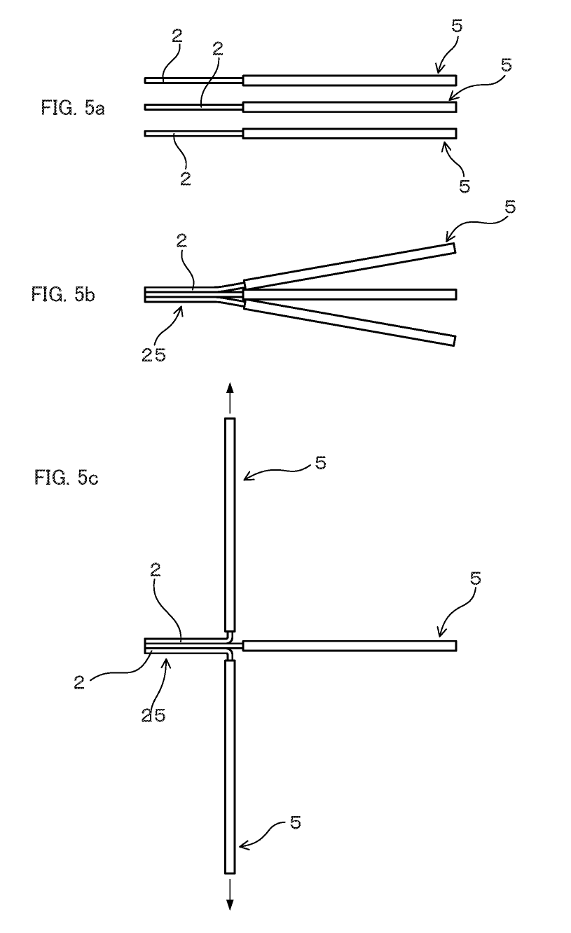

The peel strength was measured in the following manner: As shown in FIG. 5(a), three coated electric wires 5, which had been cut to a length of 150 mm, were prepared; at an end of each coated electric wire 5, the conductor wire (copper alloy stranded wire 2) was exposed by stripping a portion of the insulation coating layer 3 measuring 15 mm from the end; as shown in FIG. 5(b), the three conductor wires were welded together by ultrasonic welding to form a welded portion 25; and then as shown in FIG. 5(c), a tensile test was conducted. The ultrasonic welding was performed at a pressure of 1.2 bar and at an energy of 100 Ws and 65% using Minic-IV manufactured by Schunk Sonosystems. The tensile test was conducted in such a manner that, as shown in FIG. 5(c), two of the three coated electric wires 5 were pulled at a pulling rate of 10 mm/min while leaving one in a free state, and the maximum load up to which the welded portion 25 did not break was designated as the peel strength. The measurements were made 10 times and their average value was designated as the peel strength for evaluation. The obtained results are shown in Table 2.

As for the terminal crimp strength of the wire harness, the coated electric wire 5 was pulled at a pulling rate of 100 mm/min with the terminal 6 secured to the coated electric wire 5 and the maximum load up to which the terminal 6 was not detached was measured to be designated as the crimp strength. Also, the contact resistance between the conductor and the terminal was measured. This was measured by flowing a low-voltage, constant current of 20 mV and 10 mA through the crimped portion. The obtained results are shown in Table 3.

TABLE 2

| | | | | | | | | | | | | | | Stranded wire |
|---|---|---|---|---|---|---|---|---|---|---|---|---|---|---|
| | Chemical composition | | | | | | | | | | | | | Cross- |
| Sample | mass % | | | | | | | | | | | | ppm | sectional area |
| No. | Cu | Fe | Ti | Mg | Sn | Ag | Ni | In | Cr | Zn | Al | P | 0 | (mm²) |
| 2-1 | Bal. | 0.70 | 0.28 | 0.06 | — | — | — | — | — | — | — | — | 5 | 0.22 |
| 2-2 | Bal. | 0.91 | 0.33 | 0.01 | — | — | — | — | — | — | — | — | 10 | 0.13 |
| 2-3 | Bal. | 0.71 | 0.26 | 0.02 | — | — | — | — | — | — | — | — | 10 | 0.13 |
| 2-4 | Bal. | 0.71 | 0.14 | 0.13 | — | — | — | — | — | — | — | — | 10 | 0.13 |
| 2-5 | Bal. | 0.51 | 0.11 | 0.13 | — | — | — | — | — | — | — | — | 20 | 0.13 |
| 2-6 | Bal. | 1.00 | 0.38 | 0.04 | — | — | — | — | — | — | — | — | 10 | 0.13 |
| 2-7 | Bal. | 1.00 | 0.20 | 0.13 | — | — | — | — | — | — | — | — | 10 | 0.13 |
| 2-8 | Bal. | 0.71 | 0.14 | — | 0.05 | — | — | — | — | — | — | — | 5 | 0.13 |
| 2-9 | Bal. | 0.71 | 0.14 | — | 0.10 | — | — | — | — | — | — | — | 5 | 0.13 |
| 2-10 | Bal. | 0.71 | 0.14 | — | 0.15 | — | — | — | — | — | — | — | 5 | 0.13 |
| 2-11 | Bal. | 0.71 | 0.14 | — | 0.20 | — | — | — | — | — | — | — | 5 | 0.13 |
| 2-12 | Bal. | 0.71 | 0.30 | — | — | 0.02 | 0.01 | — | — | — | — | — | 5 | 0.13 |
| 2-13 | Bal. | 0.71 | 0.30 | — | — | — | — | 0.02 | 0.01 | 0.01 | 0.01 | 0.01 | 10 | 0.13 |
| 2-14 | Bal. | 2.10 | 0.01 | — | — | — | — | — | — | 0.07 | — | 0.04 | 10 | 0.22 |
| 2-15 | Bal. | 0.75 | 0.70 | 0.02 | — | — | — | — | — | — | — | — | 5 | 0.13 |
| C201 | Bal. | 0.30 | 0.005 | — | — | — | — | — | — | — | — | — | 30 | 0.13 |
| C202 | Bal. | — | — | 0.20 | — | — | — | — | — | — | — | — | 5 | 0.13 |

| | | | Properties | | | | |
|---|---|---|---|---|---|---|---|
| | | | | | | | Impact |
| | Heat treatment | | Tensile | Total | Electrical | Peel | resistance |
| Sample | Temperature | Time | strength | elongation | conductivity | strength | energy |
| No. | (° C.) | (h) | (MPa) | (%) | (% IACS) | (N) | (J/m) |
| 2-1 | 450 | 8 | 536 | 10 | 73 | 26 | 7 |
| 2-2 | 500 | 4 | 460 | 14 | 68 | 14 | 9 |
| 2-3 | 450 | 8 | 522 | 10 | 74 | 17 | 7 |
| 2-4 | 450 | 8 | 575 | 10 | 65 | 14 | 8 |
| 2-5 | 500 | 4 | 493 | 10 | 68 | 14 | 6 |
| 2-6 | 450 | 4 | 570 | 11 | 73 | 16 | 8 |
| 2-7 | 450 | 4 | 554 | 11 | 64 | 14 | 8 |
| 2-8 | 450 | 8 | 486 | 11 | 66 | 14 | 6 |
| 2-9 | 450 | 8 | 506 | 11 | 64 | 15 | 6 |
| 2-10 | 450 | 8 | 514 | 11 | 62 | 14 | 6 |
| 2-11 | 500 | 4 | 464 | 12 | 62 | 13 | 5 |
| 2-12 | 450 | 8 | 517 | 11 | 65 | 14 | 6 |
| 2-13 | 450 | 8 | 502 | 11 | 62 | 13 | 5 |
| 2-14 | 450 | 8 | 452 | 10 | 63 | 13 | 5 |
| 2-15 | 500 | 8 | 600 | 10 | 62 | 15 | 7 |
| C201 | 450 | 8 | 380 | 10 | 80 | 8 | 3 |
| C202 | — | — | 798 | 2 | 78 | 21 | 1 |

TABLE 3

| | Stranded | Insulation | | Terminal crimp | |
|---|---|---|---|---|---|
| | wire | coating layer | | (C/H = 0.76) | |
| | Cross-sec- | | Thick- | Crimp | Contact |
| Sample | tional area | | ness | strength | resistance |
| No. | (mm²) | Material | (mm) | (N) | (mΩ) |
| 2-1 | 0.22 | PVC | 0.2 | 94 | 0.5 |
| 2-2 | 0.13 | Engineering | 0.2 | 52 | 0.4 |
| | | plastic | | | |
| 2-3 | 0.13 | PVC | 0.2 | 63 | 0.5 |
| 2-4 | 0.13 | PVC | 0.2 | 70 | 0.4 |
| 2-5 | 0.13 | Halogen-free | 0.2 | 63 | 0.5 |
| 2-6 | 0.13 | PVC | 0.2 | 70 | 0.5 |
| 2-7 | 0.13 | PVC | 0.2 | 65 | 0.4 |
| 2-8 | 0.13 | Engineering | 0.2 | 57 | 0.4 |
| | | plastic | | | |
| 2-9 | 0.13 | PVC | 0.2 | 59 | 0.5 |
| 2-10 | 0.13 | PVC | 0.2 | 62 | 0.4 |
| 2-11 | 0.13 | PVC | 0.2 | 53 | 0.5 |
| 2-12 | 0.13 | PVC | 0.2 | 60 | 0.4 |
| 2-13 | 0.13 | PVC | 0.2 | 59 | 0.4 |
| 2-14 | 0.22 | PVC | 0.2 | 80 | 0.5 |
| 2-15 | 0.13 | Halogen-free | 0.2 | 69 | 0.4 |
| C201 | 0.13 | PVC | 0.2 | 41 | 0.4 |
| C202 | 0.13 | PVC | 0.2 | 93 | 0.5 |

As can be seen from Table 2, Samples 2-1 to 2-15 each exhibited excellent tensile strength together with excellent total elongation and also exhibited excellent properties including all of the electrical conductivity, peel strength, and impact resistance. On the other hand, Sample C201 exhibited low tensile strength and poor peel strength and impact resistance although the total elongation was very high. Sample C202 exhibited results of low total elongation and very low impact resistance in the result although the tensile strength was very high.

As can be seen from Table 3, Samples 2-1 to 2-15 exhibited very good results in both the terminal crimp strength and contact resistance. Also, Sample C202 exhibited good terminal crimp strength and good contact resistance. On the other hand, Sample C201 exhibited a very low result of crimp strength in the result.

1. A copper alloy wire for use as a conductor of an automotive electric wire, the copper alloy wire comprising in mass percent:
Fe: 0.4% or more and 2.5% or less;
Ti: 0.01% or more and 1.0% or less;
one or more elements selected from the group consisting of Mg, Sn, Ag, Ni, In, Zn, Cr, Al and P: 0.01% or more and 2.0% or less in total; and
the balance being Cu and unavoidable impurities,
wherein an O content is 20 ppm or less.

2. (canceled)

3. The copper alloy wire according to claim 1, wherein a tensile strength of the copper alloy wire is 450 MPa or more.

4. The copper alloy wire according to claim 1, wherein an element wire elongation of the copper alloy wire is 5% or more.

5. The copper alloy wire according to claim 1, wherein an electrical conductivity of the copper alloy wire is 62% IACS or more.

6. The copper alloy wire according to claim 1, wherein a wire diameter of the copper alloy wire is 0.3 mm or less.

7. A copper alloy stranded wire comprising seven copper alloy wires according to claim 1, the seven copper alloy wires being twisted together.

8. The copper alloy stranded wire according to claim 7, wherein a conductor cross-sectional area of the copper alloy stranded wire is 0.22 mm² or less.

9. The copper alloy stranded wire according to claim 7, wherein a total elongation of the copper alloy stranded wire is 10% or more.

10. The copper alloy stranded wire according to claim 7, wherein a peel strength of the copper alloy stranded wire is 13 N or more.

11. The copper alloy stranded wire according to claim 7, wherein an impact resistance energy of the copper alloy stranded wire is 5 J/m or more.

12. A coated electric wire comprising:
a conductor wire formed of a copper alloy stranded wire including a plurality of the copper alloy wires according to claim 1 being twisted together or a compressed wire obtained by subjecting the copper alloy stranded wire to compression forming; and
an insulation coating layer covering an outer periphery of the conductor wire.

13. A wire harness comprising:
the coated electric wire according to claim 12; and
a terminal attached to an end of the coated electric wire.

14. The wire harness according to claim 13, wherein a terminal crimp strength of the terminal to the coated electric wire is 50 N or more.

15. A method for producing a copper alloy wire for use as a conductor of an automotive electric wire, the method comprising the steps of:
forming a cast material comprising in mass percent Fe: 0.4% or more and 2.5% or less, Ti: 0.01% or more and 1.0% or less, one or more selected from the group consisting of Mg, Sn, Ag, Ni, In, Zn, Cr, Al and P: 0.01% or more and 2.0% or less in total, and the balance being Cu and unavoidable impurities, wherein an O content is 20 ppm or less;
forming a wrought product by subjecting the cast material to plastic working;
forming a drawn wire by subjecting the wrought product to wire drawing; and
subjecting the drawn wire to heat treatment so that the drawn wire has a tensile strength of 450 MPa or more and an elongation of 5% or more.

16. (canceled)

17. The copper alloy wire according to claim 3, wherein an element wire elongation of the copper alloy wire is 5% or more.

18. The copper alloy wire according to claim 4, wherein an electrical conductivity of the copper alloy wire is 62% IACS or more.

19. The copper alloy wire according to claim 5, wherein a wire diameter of the copper alloy wire is 0.3 mm or less.

20. A copper alloy stranded wire comprising seven copper alloy wires according to claim 6, the seven copper alloy wires being twisted together.

21. A coated electric wire comprising:
a conductor wire formed of a copper alloy stranded wire including a plurality of the copper alloy wires according to claim 6 being twisted together or a compressed wire obtained by subjecting the copper alloy stranded wire to compression forming; and
an insulation coating layer covering an outer periphery of the conductor wire.

22. A wire harness comprising:
the coated electric wire according to claim 21; and
a terminal attached to an end of the coated electric wire.
